(19) United States
(12) Patent Application Publication
(10) Pub. No.: US 2007/0082538 A1
(43) Pub. Date: Apr. 12, 2007

(54) Connector for electrically contacting consumers

(75) Inventors: Hilmar Hegner, Winnenden (DE); Walter Kreuzer, Leonberg (DE); Jurgen Otto, Illingen (DE); Harald Pubrl, Stuttgart (DE)

Correspondence Address: FOLEY AND LARDNER LLP;SUITE 500, 3000 K STREET NW, WASHINGTON, DC, 20007, US

(73) Assignee: BEHR GmbH & CO KG

(21) Appl. No.: 10/577,275

(22) PCT Filed: Sep. 13, 2004
(86) PCT No.: PCT/EP04/10216

§ 371 Date: Apr. 26, 2006

(30) Foreign Application Priority Data
Oct. 27, 2003 (DE) 103 50 233.5

(51) Int. Cl. H01R 4/24

(52) U.S. Cl. 439/396

(57) ABSTRACT

The invention relates to a connector (24) for electrically connecting consumers (34), especially in bus systems, comprising a cable section, especially for an automotive heating or air-conditioning installation. The invention provides an improved system For establishing contact between a cable section, bus-capable electronics (4) and a consumer (34), which allows for an inexpensive and variable design of cable sections and for the simultaneous standardization of the interfaces between cable sections and peripherals.

The invention relates to a plug connector for making electrical contact with loads, in particular in a bus system with a conductor run, in particular for a heating or air-conditioning system for a motor vehicle.

Modern vehicle air-conditioning systems are controlled or regulated by means of a control device which is in the form of a physical unit with an operator control unit which is arranged in the center console or in the dashboard. The operating and control device has operator control elements, such as switches, keys, rotary knobs etc., which can be used to enter user settings, such as desired temperature, desired air distribution etc. The signals which are input are electronically processed in the control device and supplied to the air-conditioning device, which comprises an air-guidance housing containing filters, heat exchangers, air-flow control elements, actuators and possibly sensors, via electrical connections, generally round conductors. The electrical components of the air-conditioning device, such as sensors and actuators, for example stepping servomotors for the air-flow control elements and the blower, are electrically connected to one another via a cable harness.

Overall, the large number of actuators and sensors entails increased outlay on cabling, that is to say also increased outlay for making contact with the individual electrical components, and associated costs. Electrical contact is usually made during assembly by means of plugs which are plugged into corresponding sockets during assembly. This is done either before or after the corresponding components and the electrical line are installed. It is also necessary to loosen the screws using a tool and release the plug connection when a component is removed. Furthermore, at least three contact points, which all constitute potential sources of faults, are provided in each case when plugs and corresponding sockets are used.

DE 196 05 999 A1 discloses making contact with a flat antenna conductor structure which is integrated in an installation part of a vehicle, in particular a vehicle window. In this case, first contacting means, which are arranged on the installation part of the vehicle, and second contacting means, which are arranged on at least one contact foot on the vehicle body, are provided for the purpose of making contact. Contact is made between the first contacting means and the corresponding second contacting means by a relative movement between the installation part of the vehicle and the contact foot during installation, with the relative movement being executed firstly by the installation part of the vehicle, for example by being placed, when the contact foot is already installed, and secondly by the contact foot, for example by being plugged, when the installation part of the vehicle is already installed. However, making contact in this way leaves something to be desired.

Modern bus systems generally comprise round conductors with commercially available round conductor plug contacts and loads, for example stepping servomotors, with integrated electronics. If the electronics fail, the load, for example the stepping servomotor, and the electronics are replaced and disposed of. It is possible to disconnect the electronics from the load only at a very high cost.

In conventional contact-making means, a large number of contact points are required between the conductor and the contacts of the load. At the same time, the entire system of round conductors with plugs, electronics and loads requires a relatively large amount of installation space.

The invention is based on the object of providing an improved plug connector.

This object is achieved by a plug connector having the features of claim 1. Advantageous refinements are the subject matter of the subclaims.

The plug connector according to the invention comprises a contact maker, which is provided with bus-compatible electronics, and a fixing element which is provided for arranging the contact maker in a housing.

The contact maker is preferably a flat component with a substantially rectangular basic shape whose width corresponds substantially to the width of the flat conductor used. The contact maker is preferably a double-sided printed circuit board. However, it is also possible for the contact maker to be a flexible printed circuit (FPC), a plastic MID component or an encapsulated punched grid. In one preferred refinement, bus-compatible electronics are arranged on a surface of the contact maker.

Contact elements, which are preferably elastic, for example spring contacts, for making contact between the contact maker and a flat conductor or between the electronics located on the contact maker and a flat conductor are located on one of the surfaces, for example the front face, of the contact maker. In one preferred refinement, the bus-compatible electronics, for example an ASIC and various SMD components, are also located on the front face of the contact maker.

Contact areas for making contact between the contact maker and a load or between the electronics located on the contact maker and a load are located on the rear face of the contact maker. Elastic contact elements, for example spring contacts, may also be provided there in place of the contact areas for the purpose of making contact with the load. The front face of the contact maker (=contact between the contact maker and the flat conductor) and the rear face of the contact maker (=contact between the contact maker and the load) are electrically connected to one another.

The fixing element is preferably a flat component with a substantially rectangular basic shape whose dimensions of length and width are greater than the corresponding dimensions of the contact maker used. The fixing element has an opening whose dimensions correspond substantially to those of the contact maker, so that the contact maker can be arranged in the opening in the fixing element.

The fixing element may, for example, be produced by injection molding plastic. In one preferred embodiment, said fixing element has positioning aids for arranging the flat conductor on the fixing element and for arranging the fixing element in the housing. The positioning aid for arranging the flat conductor on the fixing element is preferably designed in the form of one or more spikes which are integrally formed on an outer edge of the fixing element. The positioning aid for arranging the fixing element in the housing may be designed in the form of cutouts in or projections of the outer contour of the fixing element or in the form of holes or spikes. This positioning aid is preferably designed in the form of projections of the outer contour of the fixing element.

The housing comprises an upper shell and a lower shell which are produced by injection molding plastic, for example. The upper shell and the lower shell are preferably connected to one another by one or more elastic webs such that they can be joined to form the housing by being folded together, with the elastic web or webs acting as hinges. In one particularly advantageous refinement, the upper shell and the lower shell of the housing have latching means which allow the housing to be assembled without additional fastening means such as screws or the like.

The size and shape of the housing allow the contact maker and the fixing element to be accommodated in the interior of the housing. In one preferred embodiment, the housing has a positioning aid which corresponds to the positioning aid of the fixing element for arranging the fixing element in the housing. The positioning aid of the housing for arranging the fixing element in the housing may be designed in the form of cutouts in or projections of the side walls or in the form of holes or spikes. This positioning aid is preferably designed in the form of cutouts in the side walls of the upper shell and/or the lower shell of the housing, so that the projections of the outer contour of the fixing element engage in the cutouts in the side walls of the housing when the housing is assembled.

The housing has at least two openings, with the first opening being used for the flat conductor to pass through and the second opening being used for making contact between the contact maker and a load or between the electronics located on the contact maker and a load. The first opening may be formed by cutouts in a side wall of the upper shell or a side wall of the lower shell, or by cutouts in a side wall of the upper shell and the lower shell in each case. The second opening is formed by an opening in the upper shell or by an opening in the lower shell of the housing.

In order to assemble the plug connector, the flat conductor is firstly positioned on the fixing element. To this end, the flat conductor is positioned on the positioning aid of the fixing element. If the positioning aid comprises spikes which are integrally formed on an edge of the positioning element, the spikes are inserted into openings in the flat conductor which are provided for this purpose.

The flat conductor is then passed across the fixing element to the opposite edge. In the process, the flat conductor covers the opening in the fixing element whose dimensions correspond substantially to those of the contact maker. The contact maker is then inserted into the opening in the fixing element such that its front face touches the flat conductor and is pressed into the opening in the fixing element.

The fixing element with the contact maker inserted and the flat conductor running between the latter is then inserted into the upper shell or the lower shell of the housing and the housing is then assembled, so that the flat conductor runs through the first opening in the housing and the contacts of the contact maker for making contact with a load are accessible from the outside through the second opening in the housing.

The surrounding housing comprising the fixing element and the contact maker now constitutes a so-called smart connector which is connected to a flat conductor.

This smart connector is then attached to a load by the contacts, which are accessible from the outside, of the contact maker for making contact with a load such that the contacts of said smart connector form an electrical connection with the corresponding contacts of the load, for example spring contacts.

The present invention provides an improved system for making contact between a cable section, bus-compatible electronics and a load, which system allows the cable sections to be designed in a cost-effective and variable manner and at the same time allows the interfaces of cable sections to peripheral devices to be standardized.

The plug connector according to the invention makes it possible to standardize a cable section since the only difference between different variants is that the length of the lines, the number of loads, the amount of electronics, and the position of the latter changes. When the cable sections are manufactured in fully automated fashion, the position of the loads and the electronics can therefore be changed solely by the software in the production plant. The manufacture of cable sections is simplified and costs are reduced.

One further advantage of the invention is simple replacement of the electronics or the loads if repairs are necessary, as a result of which the cost of repairs and the effort required to make said repairs fall.

The reduction in contact points between the conductor up to the contacts of the loads is likewise considered favorable since the quality of the cable section is increased just by this reduction in contact points.

One exemplary embodiment of the invention is explained in greater detail with reference to drawings, in which:

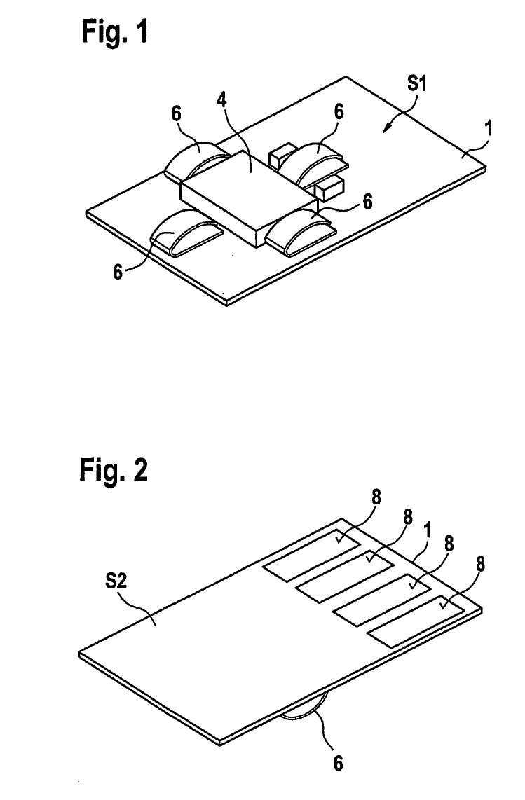

FIG. 1 schematically shows a perspective illustration of a surface, for example the front face, of a contact maker for a plug connector,

FIG. 2 shows a perspective illustration of the rear face of the contact maker from FIG. 1,

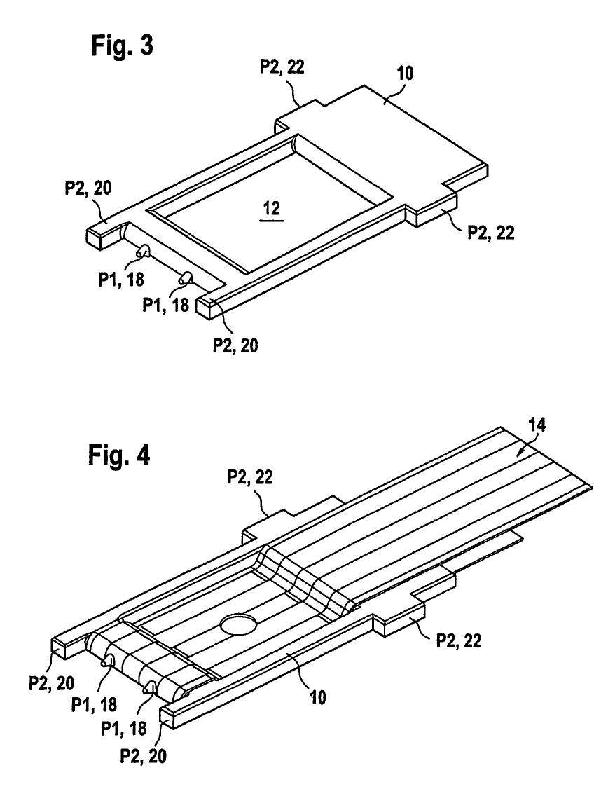

FIG. 3 shows a perspective illustration of a fixing element for a plug connector,

FIG. 4 shows the fixing element with a flat conductor inserted,

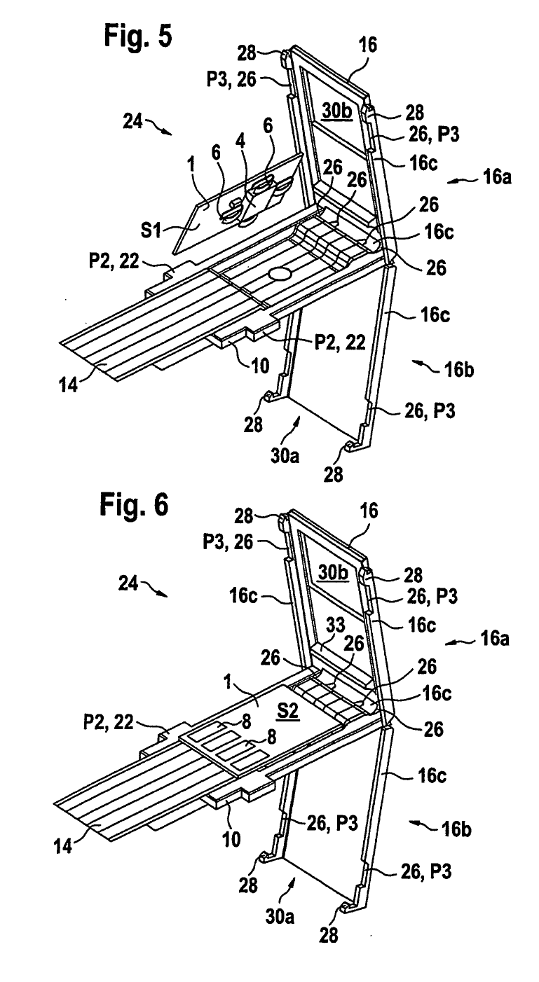

FIG. 5 shows the constituent parts of the plug connector according to the invention in a first assembly step,

FIG. 6 shows the constituent parts of the plug connector according to the invention in a second assembly step,

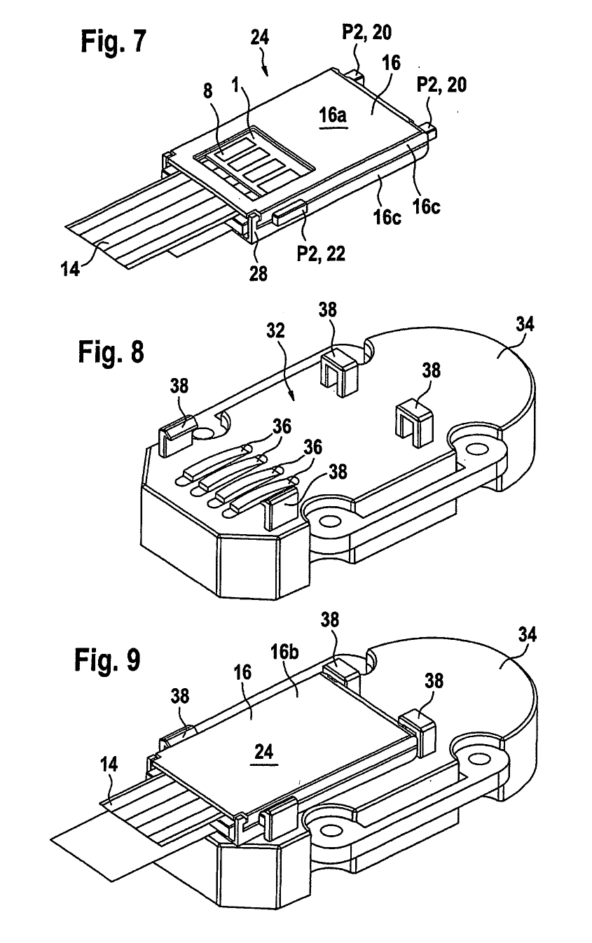

FIG. 7 shows the constituent parts of the plug connector according to the invention in a third assembly step,

FIG. 8 shows the contacting point of a load, and

FIG. 9 shows the contacting point of a load with a plug connector according to the invention coupled to it.

Parts which correspond to one another are provided with the same reference symbols in all of the figures.

FIG. 1 illustrates a surface, for example the front face S1, of a contact maker 1 (also called component carrier unit).

Bus-compatible electronics 4 are arranged on the front face S1 of the contact maker 1. Elastic spring contacts in the form of contact elements 6 for making electrical/electronic contact with the electronics 4 located on the contact maker 1 are also arranged on the front face S1 of the contact maker 1.

FIG. 2 illustrates the rear face S2 of the contact maker 1.

Contact areas 8 for making electrical/electronic contact between the electronics 4 located on the contact maker 1 and a load are located on the rear face S2 of the contact maker 1.

FIG. 3 illustrates a fixing element 10 which is provided for the purpose of simple assembly and reliable arrangement of the contact maker 1.

The fixing element 10 is a flat, substantially rectangular component whose external dimensions of length and width are greater than the corresponding dimensions of the contact maker 1. The fixing element 10 has a rectangular opening 12 whose dimensions correspond substantially to those of the contact maker 1, so that the contact maker 1 can be arranged in the opening 12 in the fixing element 10.

The fixing element 10 is integrally produced from plastic and has positioning aids P1 and P2 for arranging a flat conductor 14 on the fixing element 10, as illustrated in FIG. 4, and respectively for arranging the fixing element 10 in the housing 16, as illustrated in FIG. 5.

The positioning aid P1 for arranging the flat conductor 14 on the fixing element 10 comprises two spikes 18 which are integrally formed on an outer edge at one end of the fixing element 10. The positioning aid P2 for arranging the fixing element 10 in the housing 16 comprises two pairs of projections 20, 22 of the outer contour of the fixing element 10. In this case, a first pair of projections 20 is arranged at the ends of the outer edge at one end of the fixing element 10, on which outer edge the two spikes 18 are also located, whereas each of a second pair of projections 22 is arranged on one of the two opposite lateral outer edges of the fixing element 10.

FIG. 4 illustrates the fixing element 10 with the flat conductor 14 inserted.

In order to position the flat conductor 14 on the fixing element 10, the spikes 18 of the positioning aid P1 for arranging the flat conductor 14 on the fixing element 10 are inserted into openings in the flat conductor 14 which are provided for this purpose. The flat conductor 14 is then passed across the fixing element 10 to its opposite edge. In the process, the flat conductor 14 covers the opening 12 in the fixing element 10 whose dimensions correspond substantially to those of the contact maker 1. In other words: the contact maker 1 is a rectangular, double-sided printed circuit board whose width corresponds substantially to the width of the flat conductor 14 used. The front face S1 and the rear face S2 of the contact maker 1 are electrically connected to one another.

FIG. 5 illustrates all of the constituent parts—contact maker 1, fixing element 10, housing 16 and flat conductor 14—of a plug connector 24 according to the invention in a first assembly step.

The housing 16 is a shaped plastic part which comprises an upper shell 16a, a lower shell 16b and transverse-side and longitudinal-side webs 16c which connect the upper shell 16a and the lower shell 16b. The transverse-side web 16c does not extend across the entire width of the housing 16 but leaves a section free at each of the two ends of the housing face in question, the width of these sections corresponding substantially to the width of the projections 20 which are arranged at the ends of the outer edge at one end of the fixing element 10.

As a result, the upper shell 16a and the lower shell 16b can be joined to form the housing 16 by being folded together, with the transverse-side web 16c acting as a hinge and forming a side wall of the housing 16 in the assembled state. The transverse-side web 16c and/or the longitudinal-side webs 16c may be elastic or dimensionally stable, depending on the type and design of the housing 16. Cutouts 26 in the side wall of the housing 16 are provided on both sides of the transverse-side web 16c and are suitable for receiving the positioning aid P2 for arranging the fixing element 10 in the housing 16. On the side which is opposite the transverse-side web 16c, the upper shell 16a and the lower shell 16b of the housing 16 have latching elements 28 which allow the housing 16 to be assembled without additional fastening means.

The size and shape of the housing 16 allow the contact maker 1 and the fixing element 10 to be arranged in the interior of the housing 16. The housing 16 has a positioning aid P3 in the form of cutouts 26 in the side walls or longitudinal-side webs 16c of the upper shell 16a and the lower shell 16b of the housing 16, which cutouts correspond to the positioning aid P2 of the fixing element 10 for arranging the fixing element 10 in the housing 16, so that the projections 22 of the outer contour of the fixing element 10 engage in the cutouts 26 in the side walls of the housing 16 when the housing 16 is assembled.

The housing 16 also has two openings 30a, 30b, with the first opening 30a being used for the flat conductor 14 to pass through and the second opening 30b being used for making contact between the contact maker 1 and a load or between electronics 4 located on the contact maker 1 and a load.

The first opening 30a is formed in such a way that neither the upper shell 16a nor the lower shell 16b of the housing 16 have a side wall on the side which is opposite the transverse-side web 16c. This side of the housing 16 therefore remains open in the assembled state. The second opening 30b is formed by a rectangular opening in the upper shell 16a.

The flat conductor 14 is firstly positioned on the fixing element 10 in the described manner. The fixing element 10 is then inserted into the open housing 16 such that the two projections 20 of the outer contour of the fixing element 10, which form the positioning aid P2 of the fixing element 10 for arranging the fixing element 10 in the housing 16, engage in the two cutouts 26 which remain on both sides of the longitudinal-side webs 16c.

The contact maker 1 is inserted into the opening 12 in the fixing element 10 such that its front face S1 touches the flat conductor 14 and is pressed into the opening 12 in the fixing element 10. This establishes electrical contact between the elastic contact elements 6 on the front face S1 of the contact maker 1 and the conductor tracks of the flat conductor 14. At the same time, the bus-compatible electronics 4 are encapsulated, so that they are protected against external influences.

FIG. 6 illustrates the constituent parts of the plug connector 24 according to the invention in a second assembly step.

The contact maker 1 is inserted into the opening 12 in the fixing element 10. The housing 16 is still open, with the second opening 30b, which is located in the upper shell 16a, being located above the rear face S2 of the contact maker 1 which faces outward. The housing 16 is then assembled by the latching elements 28 of the upper shell 16a and the lower shell 16b being folded together and latched.

FIG. 7 illustrates the constituent parts of the plug connector 24 according to the invention in a third assembly step.

The housing 16 is assembled by the latching elements 28 of the upper shell 16a and the lower shell 16b being folded together and latched. The flat conductor 14 runs through the first opening 30a in the housing 16 and into said housing. The second opening 30b in the housing 16 is positioned above the contact areas 8 which are arranged in the rear face S2 of the contact maker 1, so that the electronics 4 located on the contact maker 1 can come into contact with a load.

FIG. 8 illustrates the contacting point 32 of a load 34.

Elastic contact elements 36 and retaining bodies 42 for the plug connector 24 according to the invention are located on said contacting point.

FIG. 9 illustrates the contacting point 32 of a load 34 with the plug connector 24 according to the invention coupled to it.

The plug connector 24 according to the invention is pushed into the retaining bodies 38 for the plug connector 24 according to the invention. The second opening 30b in the housing 16 faces the elastic contact elements 36 of the contacting point 32 of the load 34, so that electrical contact is produced between these elastic contact elements 36 and the contact areas 8 on the rear face S2 of the contact maker 1.

1. A plug connector for making electrical contact with a load in particular in a bus system with a conductor run, comprising a contact maker which is provided with bus-compatible electronics and a fixing element which is provided for arranging the contact maker in a housing.

2. The plug connector as claimed in claim 1, wherein the bus-compatible electronics are arranged on a surface, in particular on a front face of the contact maker.

3. The plug connector as claimed in claim 2, wherein contact elements for making contact between the contact maker or the electronics located on the contact maker and a flat conductor are arranged on the front face of the contact maker.

4. The plug connector as claimed in claim 1, wherein contact areas or contact elements for making contact between the contact maker or the electronics located on the contact maker and a load are arranged on the rear face of the contact maker.

5. The plug connector as claimed in claim 4, wherein the front face and the rear face of the contact maker are electrically connected to one another.

6. The plug connector as claimed in claims claim 1, wherein the fixing element has an opening whose dimensions correspond substantially to those of the contact maker so that the contact maker can be arranged in the opening in the fixing element.

7. The plug connector (24) as claimed in wherein the fixing element has positioning aids for arranging the flat conductor on the fixing element and for arranging the fixing element in the housing.

8. The plug connector as claimed in claim 7, wherein the positioning aid of the fixing element for arranging the flat conductor on the fixing element is formed from one or more spikes which are integrally formed on an outer edge of the fixing element.

9. The plug connector as claimed in claim 7, wherein the positioning aid for arranging the fixing element in the housing is formed from projections of the outer contour of the fixing element.

10. The plug connector as claimed in claim 1, wherein the housing comprises an upper shell and a lower shell.

11. The plug connector as claimed in claim 1, wherein the size and shape of the housing are selected such that the contact maker and the fixing element are accommodated in the interior of the housing.

12. The plug connector as claimed in claim 1, wherein the housing has at least two openings with a first opening for the flat conductor to pass through being formed by cutouts in a side wall of the upper shell and/or the lower shell and a second opening for making contact between the contact maker or the electronics located on the contact maker and a load being formed by an opening in the upper shell or in the lower shell of the housing.

13. The plug connector as claimed in claim 1, wherein the upper shell and the lower shell are connected to one another by one or more webs such that they are joined to form the housing by being folded together.

14. The plug connector as claimed in claim 13, wherein the web or webs act as hinges.

15. The plug connector as claimed in claim 1, wherein the upper shell and the lower shell of the housing have latching elements which allow the housing to be assembled without additional fastening means.

16. The plug connector as claimed in claim 1, wherein the housing has a positioning aid which corresponds to the positioning aid of the fixing element for arranging the fixing element in the housing and is made up of cutouts in the side walls of the upper shell and/or the lower shell of the housing, so that the projections of the fixing element engage in the cutouts in the housing when the housing is assembled.
